(19) United States
(12) Patent Application Publication
(10) Pub. No.: US 2008/0143710 A1
(43) Pub. Date: Jun. 19, 2008

(54) Method for image rendering

(75) Inventors: Ruen-Rone Lee, Taipei (TW); Chih-Hsien Huang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/810,748

(22) Filed: Jun. 7, 2007

(30) Foreign Application Priority Data
Dec. 15, 2006 (TW) 95147073

(51) Int. Cl. G06T 15/00

(52) U.S. Cl. 345/419

(57) ABSTRACT

A method for image rendering is disclosed. A leftmost block of a top tile row (R_{TOP}) is defined as an initial block (T_{INIT}) and a reference pixel of the initial block is defined as an initial pixel. Block offset along the X and Y axes (Δx and Δy) between a leftmost block of a current tile row and the initial block is calculated and attributes of a reference of the leftmost block is calculated using a formula A_{LEFT}=A_{INIT}+dA/dx*n*Δx+dA/dy*n*Δy. Block offset between a current block and the leftmost block (Δz) is calculated, in which the current block and the leftmost block reside in the same tile row. Attributes of reference pixels of the current block are calculated using a formula A_{CURRENT}=A_{LEFT}+dA/dx*n*Δz.

### BACKGROUND OF THE INVENTION

1. Field of the Invention

The invention relates to an image processing, and more particularly to a method for image rendering.

2. Description of the Related Art

Computer graphics applied to simulation, computer-aided design (CAD), computer-assisted instruction (CAI), and similar, are implemented using computer hardware and software. Image rendering converts a three dimensional object to a two dimensional object in a plane, by generating lines, circles, ellipses, polygons, and so forth, and processes the display of polygons and shading procedures.

Generation of lines and polygons is implemented using a plane equation, a digital differential analyzer (DDA), and an improved DDA. The improved DDA further comprises tile based DDA and scanline based DDA.

FIG. 1 is a schematic view of rendering a triangle using a tile based DDA method. The tile based DDA cuts a triangle frame to multiple tiles. As shown in FIG. 1, a triangle is divided to 4×4 blocks (also named tiles, symbolized by T₁˜T₁₉). Blocks T₁˜T₁₉ are sequentially rendered from the left-top pixel of each block (symbolized by A₁˜A₁₉). When attributes of pixel B₁ are rendered, for example, attributes of left-top pixel A₆ of block T₆ are obtained using T_{A}(tx,ty)=T_{A}(tx−1,ty)+4×dA/dx, indicating the attributes of block T₆ are attributes of block T₅ plus quadruple differential values of pixel A₅. The number 4 in the formula refers to a 4×4 pixel area of each block. Next, attributes of pixel B₁ are derived from pixel A₆ using f_{A}(x,y)=(T_{A}(tx,ty)+n×dA/dy)+m×dA/dx, where tx and ty represent block coordinates of pixel A6, m=x mod 4, n=y mod 4, and A represents image attributes comprising depth, colors, texture, coordinates, and others. As described, each block is rendered in the direction of the arrow shown in FIG. 1.

FIG. 2 is a schematic view of rendering a triangle using a scanline based DDA method. The scanline based DDA cuts a triangle frame based on multiple pixels residing in the same tile row. Referring to FIG. 2, a triangle is divided to 18 tile rows and is rendered from an initial base row R₁, such that pixels of each tile row are rendered from the top to the bottom and from the left to the right. When attributes of pixel B2 are rendered, for example, attributes of tile row R₇ and the leftmost pixel of tile row R₈ are rendered using f_{A}(x,y)=f_{A}(x, y−1)+dA/dy, and pixels from the leftmost pixel to B₂ are rendered one by one using f_{A}(x,y)=f_{A}(x−1,y)+dA/dx, where A represents image attributes comprising depth, colors, texture, coordinates, and the like. As described, each pixel is rendered according to the direction of the arrow in FIG. 2.

Errors accumulated using the tile based DDA and the scanline based DDA during image rendering affect subsequent image rendering resulting in substantial defects. As shown in FIG. 1, for example, when pixel B₁ is rendered, attributes of pixels A₁˜A₅ must first be calculated using the described formulas to accordingly render pixel A₆, and pixel B₁ is thus rendered based on attributes of pixel A₆, pixel A₂ is rendered based on pixel A₁, pixel A₃ is rendered based on pixel A₂, and so forth. As described, attributes of pixels A₁˜A₅ are calculated using differential formulas to compensate for generated and accumulated errors. If errors for a pixel are considerable, when pixel B₁ is rendered, expected effects of pixel B₁ may not be obtained due to the accumulated errors. Further, as shown in FIG. 2, when pixel B₂ is rendered, attributes of pixel rows R₁˜R₇ must first be calculated using the described formulas, in which pixel row R₂ is rendered based on pixel row R₁, pixel row R₃ is rendered based on pixel row R₂, and so forth. If errors for a pixel row are considerable, when pixel B₂ is rendered, expected effects of pixel B₂ may not be obtained due to the accumulated errors.

FIGS. 3A˜3D are schematic views of rendering line segments using a conventional image rendering method that accumulates a great number of errors. FIG. 3A shows real lines L₁ and L₂ to be rendered. The lines displayed and viewed from the “depth” arrow as shown in FIG. 3B, comprise covered portions of lines L₁ and L₂ represented by dotted lines. As described, the display of lines L₁ and L₂ affected by accumulated errors may be displayed and viewed as shown in FIGS. 3C and 3D.

FIGS. 4A˜4C are schematic views of rendering triangles using a conventional image rendering method that accumulates a great number of errors. Additionally, as described, if errors for a pixel are considerable, when a subsequent pixel is rendered, expected effects of the subsequent pixel may not be obtained due to the accumulated errors. As shown in FIG. 4A, triangle objects O₁ and O₂ should be rendered. FIG. 4B shows normally rendered triangle objects O₁ and O₂, in which a portion of triangle object O₁ is covered by triangle object O₂. FIG. 4C shows abnormally rendered triangle objects O₁ and O₂, in which a portion of triangle object O₁ is revealed.

Further, conventional image processing methods implement image rendering by improved software applications, but image rendering implemented by hardware devices increases hardware cost. Thus, an improved method for image rendering is desirable.

### BRIEF SUMMARY OF THE INVENTION

Methods for image rendering are provided. An exemplary embodiment of a method for image rendering applied to rendering an image object comprises the following. The image object comprises a plurality of tile rows, each tile row comprises at least one tile, and each tile comprises a reference pixel. A top tile row (R_{TOP}), a bottom tile row, and a current tile row of the image object are defined. The leftmost block of the top tile row is defined as an initial block (T_{INIT}) and the reference pixel of the initial block is defined as an initial pixel. Block offset along the X and Y axes (Δx and Δy) between a leftmost block of the current tile row and the initial block is calculated. Attributes (A_{LEFT}) of a reference pixel of the leftmost block are calculated using a formula A_{LEFT}=A_{INIT}+dA/dx*n*Δx+dA/dy*n*Δy, where A_{INIT} indicates attributes of the initial pixel, and n is referred to a block of size n×n. Block offset (Δz) between a current block and the leftmost block is calculated. The current block and the leftmost block reside in the same tile row. Attributes (A_{CURRENT}) of a reference pixel of the current block are calculated using a formula A_{CURRENT}=A_{LEFT}+dA/dx*n*Δz, where Δz is the block offset between the current block and the leftmost block and n relates to the block size.

Another embodiment of a method for image rendering applied to rendering an image object comprises the following. The image object comprises a plurality of tile rows, each tile row comprises at least one tile, and each tile comprises a reference pixel. The leftmost block of a top tile row (R_{TOP}) is defined as an initial block (T_{INIT}) and a reference pixel of the initial tile is defined as an initial pixel. Block offset along the Y axis (Δy) between a current tile row and the initial block is calculated. Attributes (A_{yTILE}) of a reference pixel vertically intersecting the initial pixel of the current tile row are calculated using a formula A_{yTILE}=A_{INIT}+dA/dy*n*Δy, where A_{INIT} indicates attributes of the initial pixel. Block offset along the X axis (Δx) between a current block and the initial block is calculated. The current block and the vertically intersecting reference pixel reside in the same tile row. Attributes (A_{CURRENT}) of a reference pixel of the current block are calculated using a formula A_{CURRENT}=A_{yTILE}+dA/dx*n*Δx, where n relates to the block size.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of rendering a triangle using a tile based DDA method;

FIG. 2 is a schematic view of rendering a triangle using a scanline based DDA method;

FIGS. 3A˜3D are schematic views of rendering line segments using a conventional image rendering method that accumulates a great number of errors;

FIGS. 4A˜4C are schematic views of rendering triangles using a conventional image rendering method that accumulates a great number of errors;

FIG. 5 is a schematic view of an embodiment of a method for image rendering;

FIGS. 6A and 6B are workflows of the method for image rendering shown in FIG. 5;

FIG. 7 is a schematic view of another embodiment of a method for image rendering; and

FIGS. 8A and 8B are workflows of the method for image rendering shown in FIG. 7.

### DETAILED DESCRIPTION OF THE INVENTION

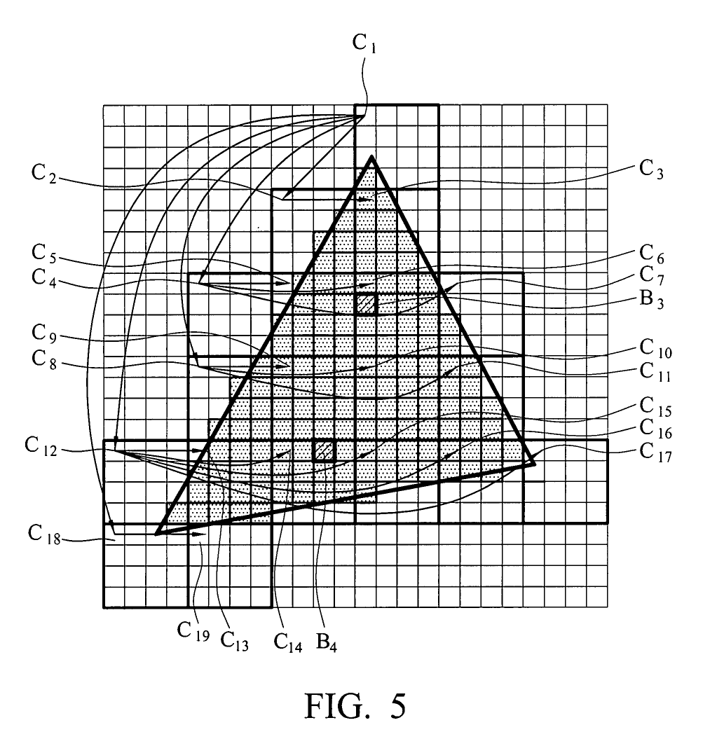

Several exemplary embodiments of the invention are described with reference to FIGS. 5 through 8, which generally relate to an image rendering. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a method for image rendering, improving conventional DDA methods to rapidly and accurately render images.

Images attributes (A) comprise depth, colors, texture, coordinates, and the like, which are required during the image rendering but are not further described below.

An embodiment of an image rendering method reduces differential times to control rendering errors, thus reducing the probability of abnormal display and limiting the degree of abnormal display.

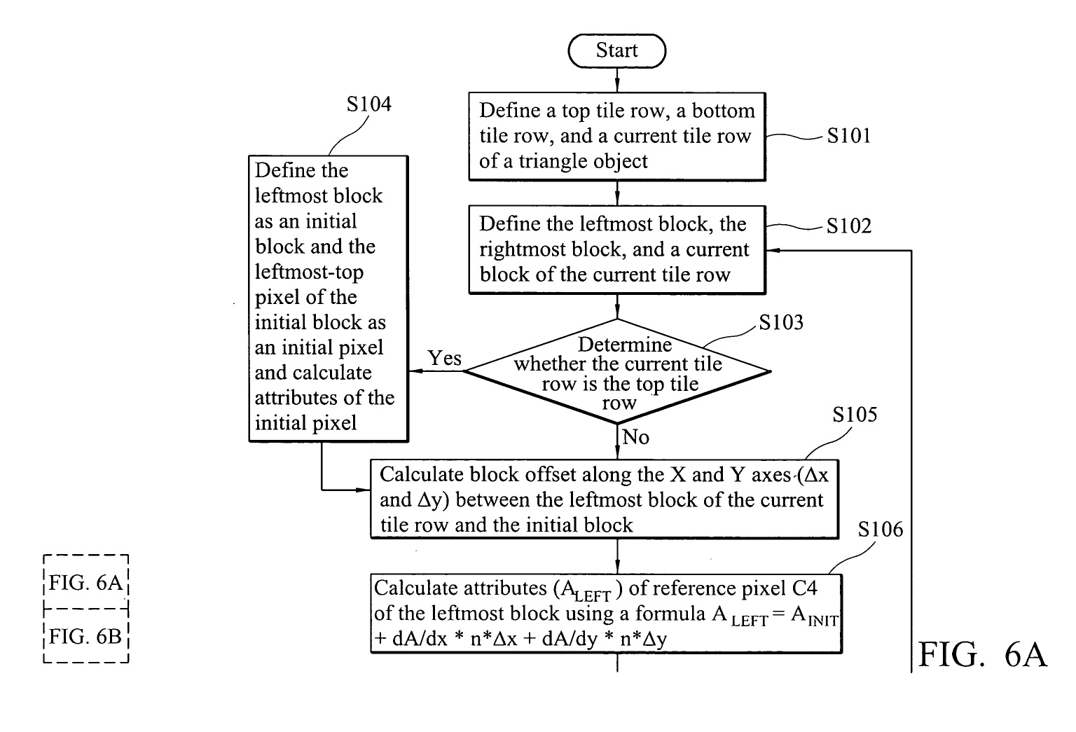

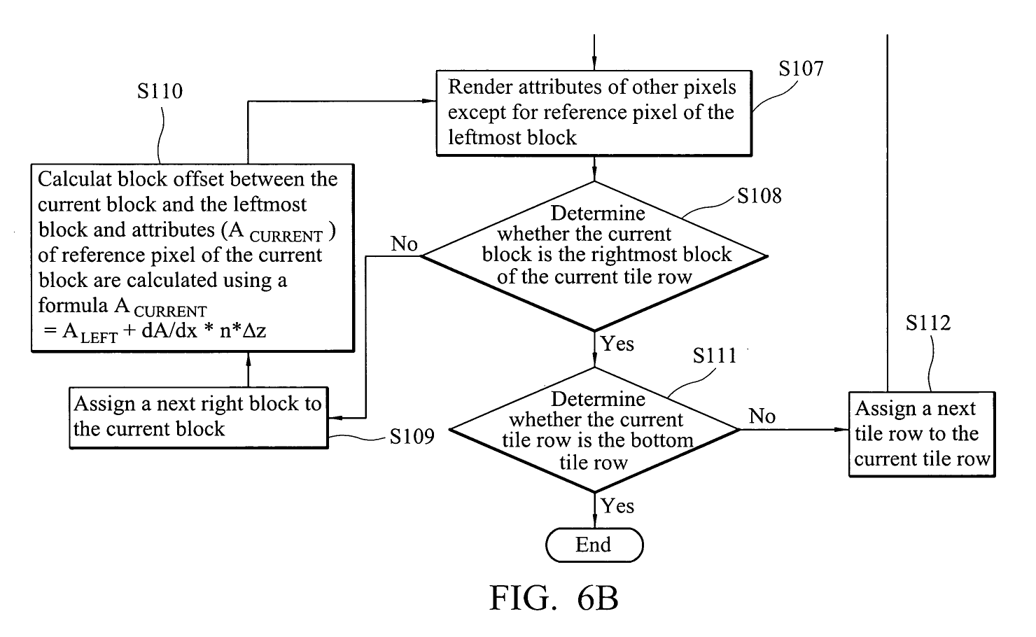

FIG. 5 is a schematic view of an embodiment of a method for image rendering. FIGS. 6A and 6B are workflows of the method for image rendering shown in FIG. 5.

It is noted that an embodiment of an image rendering method renders, but is not limited to, a triangle object, which can be applied to render quadrangles, circles, and so forth. A rendered image object comprises a plurality of tile rows, each tile row comprises at least one block, and each block comprises a reference pixel. A reference pixel is the leftmost-top pixel of a block, referred to render attributes of other pixels of the block and render reference pixels of other blocks. As shown in FIG. 5, a triangle object comprises six tile rows. The first tile row comprises a block comprising a reference pixel C₁. The second tile row comprises two blocks comprising reference pixels C₂ and C₃. The third and fourth tile rows comprise, respectively, four blocks comprising reference pixels C₄˜C₇ and C₈˜C₁₁. The fifth tile row comprises six blocks comprising reference pixels C₁₂˜C₁₇. The final tile row comprises two blocks comprising reference pixels C₁₈ and C₁₉.

Referring to FIGS. 5 and 6, a top tile row (R_{TOP}, in which reference pixel C₁ resides), a bottom tile row (R_{BOTTOM}, in which reference pixels C₁₈ and C₁₉ reside), and a current tile row (R_{CURRENT}, in which reference pixels C₄˜C₇ of this embodiment reside) of a triangle object are defined (step S101). The image rendering begins from the top tile row, thus, the top tile row is defined as the current tile row (R_{CURRENT}=R_{TOP}), and the top tile row serves as the current tile row even if selected rendering targets are tile rows comprising reference pixels C₄˜C₇. The leftmost block (T_{LEFT}), the rightmost block (T_{RIGHT}), and a current block (T_{CURRENT}) of the current tile row are defined (step S102). Since the top tile row is the initial row and comprises only one block, the block in which reference pixel C₁ resides serves as leftmost block (T_{LEFT}), the rightmost block (T_{RIGHT}), and the current block (T_{CURRENT}) of the current tile row.

It is determined whether the current tile row is the top tile row (step S103). If the current tile row is the top tile row (R_{CURRENT}=R_{TOP}), an initial process defines the leftmost block (T_{LEFT}) of the top tile row (R_{TOP}) an initial block (T_{INIT}, in which reference pixel C₁ of this embodiment reside), the leftmost-top pixel (a reference pixel) of the initial block is defined as an initial pixel, and attributes (A_{INIT}) of the initial pixel are calculated (step S104). If the current tile row is not the top tile row (R_{CURRENT}≠R_{TOP}) or the initial process has been performed, block offset along the X and Y axes (Δx and Δy) between the leftmost block of the current tile row and the initial block is calculated (step S105). An embodiment of the image rendering describes the rendering of the current tile row but omits description of the top tile row for brevity, such that the process loops to step S112 to completely render blocks of the second tile row and blocks of the third tile row in which reference pixels C₄˜C₇ reside are rendered, is described in the following.

The process returns to step S102, and the blocks in which reference pixels C₄ and C₇ reside serve as the leftmost and the rightmost blocks (T_{LEFT} and T_{RIGHT}) of the current tile row (R_{CURRENT}), respectively. Additionally, a current block to be rendered is defined as the leftmost block of the current tile row (T_{CURRENT}=T_{LEFT}) in which reference pixel C₄ resides is also the leftmost block and the current block.

When a current block in which reference pixels C₄ and C₇ reside is rendered, the leftmost block (in which reference pixel C₄ resides) of the current tile row is preferably rendered, and block offset along the X and Y axes (Δx and Δy) between the block in which reference pixel C₄ resides and that in which reference pixel C₁ resides is calculated. As shown in FIG. 5, the block offset along the X and Y axes (Δx and Δy) are 2 respectively.

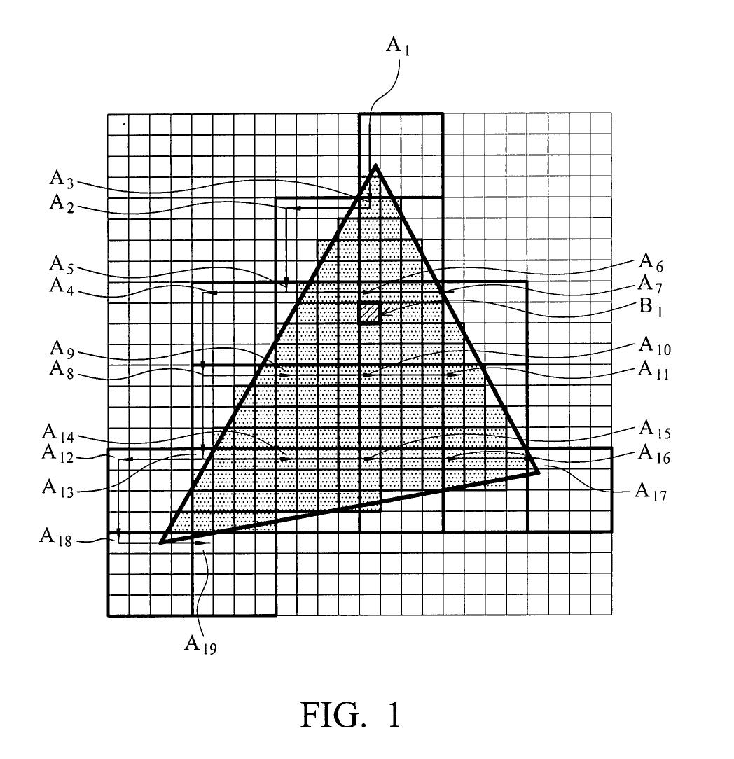

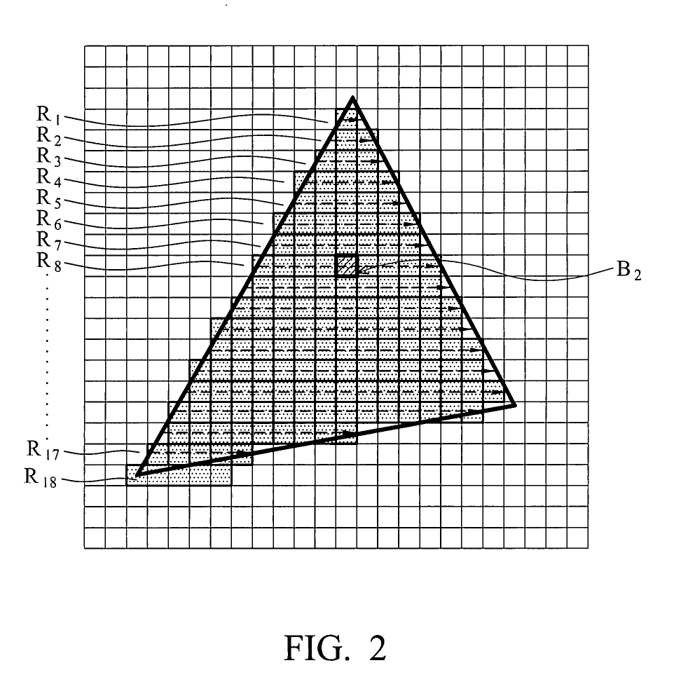

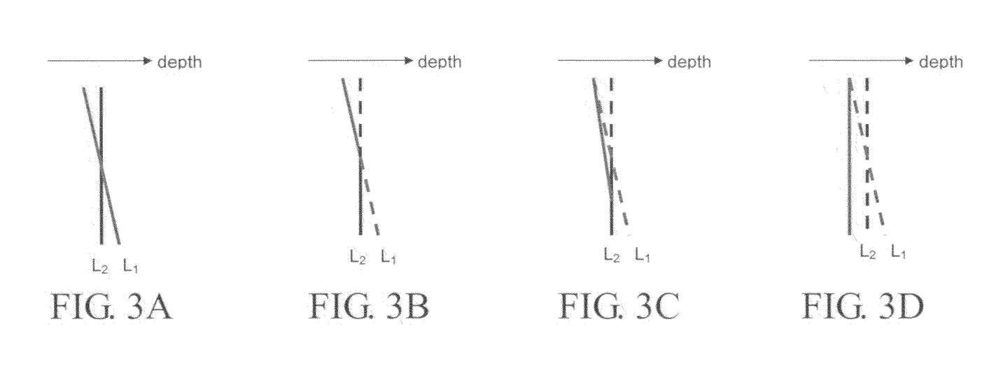

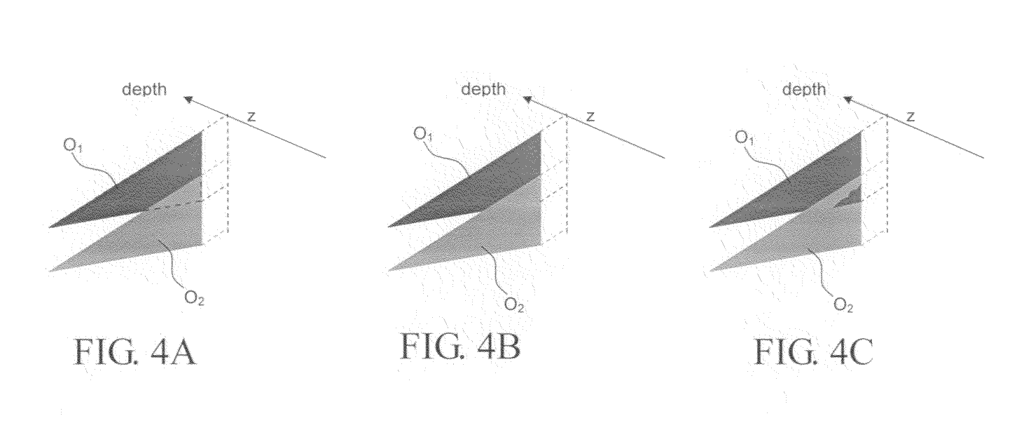

Next, attributes (A_{LEFT}) of reference pixel C₄ of the leftmost block are calculated using a formula A_{LEFT}=A_{INIT}+dA/dx*n*Δx+dA/dy*n*Δy (step S106), where A_{INIT} indicates attributes of initial pixel C₁ and n relates to the block size. For example, n=4 for a 4×4 block, but is not intended to limit the invention. Next, attributes of other pixels except for reference pixel C₄ of the leftmost block are rendered (step S107). It should be noted that, based on step S106 and compared with the conventional method shown in FIG. 1, when the leftmost block of the current tile row (besides the initial block in which reference pixel A₁ resides) is rendered, an embodiment of the image rendering does not preferably calculate attributes of reference pixels A₃, A₂, and A₅ to obtain attributes of reference pixel A₄. Alternatively, when attributes (A_{INIT}) of initial pixel C₁ of the initial block is obtained, attributes (A_{LEFT}) of reference pixel C₄ is directly obtained using steps S105 and S106, such that attribute errors for reference pixels C₃, C₂, and C₅ are not accumulated.

Next, it is determined whether the current block is the rightmost block of the current tile row (step S108). If the current block is not the rightmost block of the current tile row, a next right block is assigned to the current block (step S109). In this embodiment, the block in which pixel B₃ resides is assigned to the current block for simplification. When the current block is rendered, block offset (Δz, Δz=2 herein) between the current block in which reference pixel C₆ resides and the leftmost block in which reference pixel C₄ resides is calculated. Attributes (A_{CURRENT}) of reference pixel C₆ of the current block (the next right block) are calculated using a formula A_{CURRENT}=A_{LEFT}+dA/dx*n*Δz, where the current block and the leftmost block reside in the same tile row, Δz is the block offset between the current block and the leftmost block, and n relates to the block size (identical to that described in step S106) (step S110). The process then proceeds to step S107, attributes of other pixels except for reference pixel C₆ of the current block are rendered based on attributes of reference pixel C₆, and the block in which pixel B₃ resides can be rendered. It should be noted that, based on step S110 and compared with the conventional method shown in FIG. 1, when the current block of the current tile row is rendered, an embodiment of the image rendering of the invention calculates the attributes of reference pixel A₆ without referring to the attributes of reference pixel A₅ except for the leftmost block (the block in which reference pixel A₄ resides). Alternatively, when attributes (A_{LEFT}) of reference pixel C₄ of the leftmost block is obtained, attributes (A_{CURRENT}) of reference pixel C₆ is directly obtained using steps S108, S109, and S110, such that attribute errors for reference pixel C₅ are not accumulated.

As described, when the block in which reference pixel B₃ resides is rendered using an embodiment of the image rendering, attribute errors for reference pixels C₃, C₂ and C₅ are not accumulated, such that the degree accumulated errors can be reduced.

If the current block is the rightmost block of the current tile row, it is then determined whether the current tile row is the bottom tile row (step S111). If the current tile row is the bottom tile row, the process terminates. If the current tile row is not the bottom tile row, a next tile row is assigned to the current tile row (step S112) and the process proceeds to step S102 to render the next tile row.

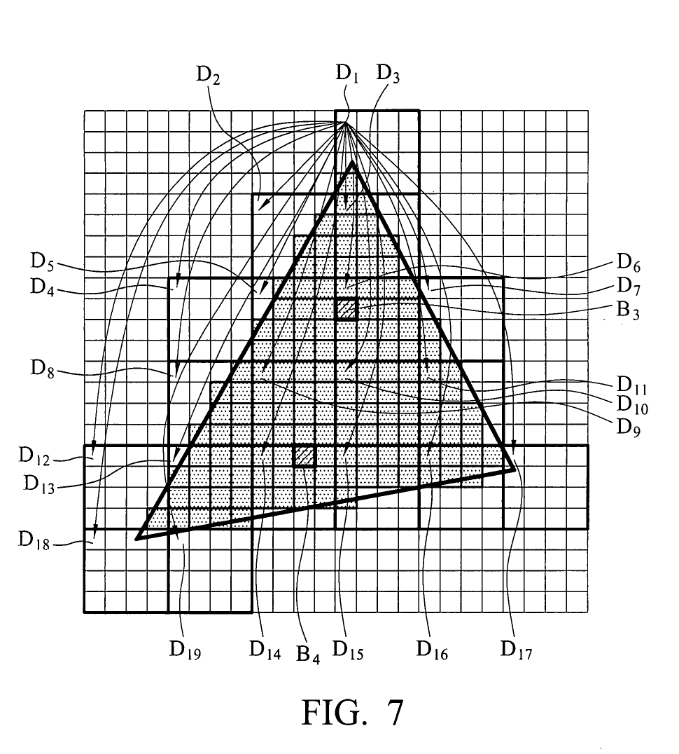

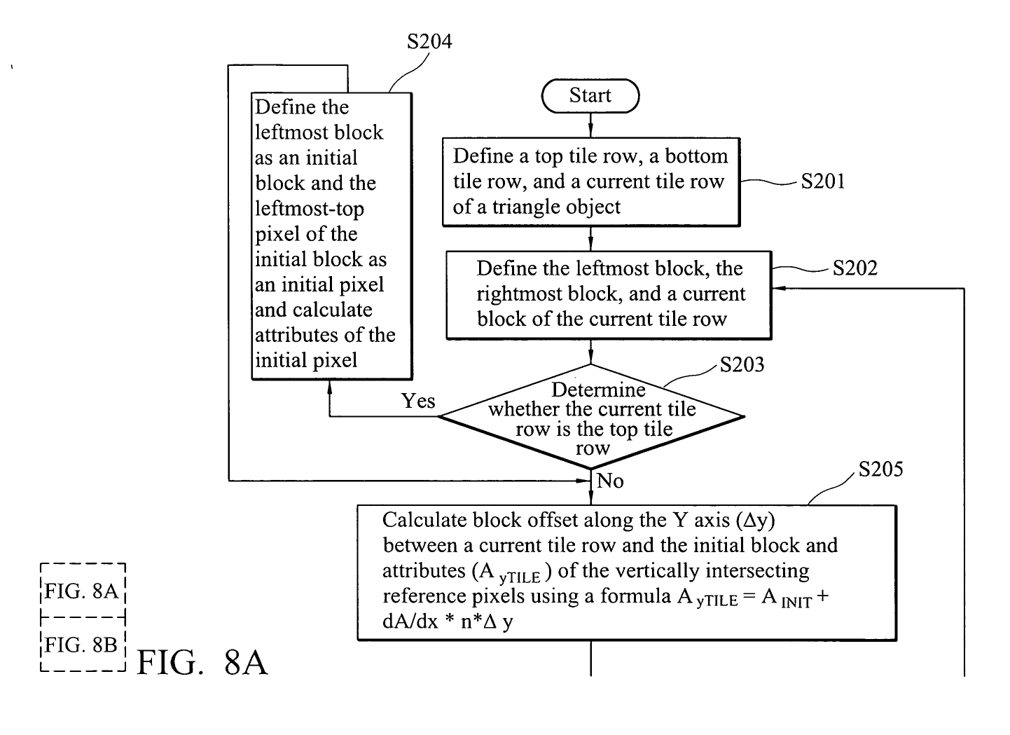

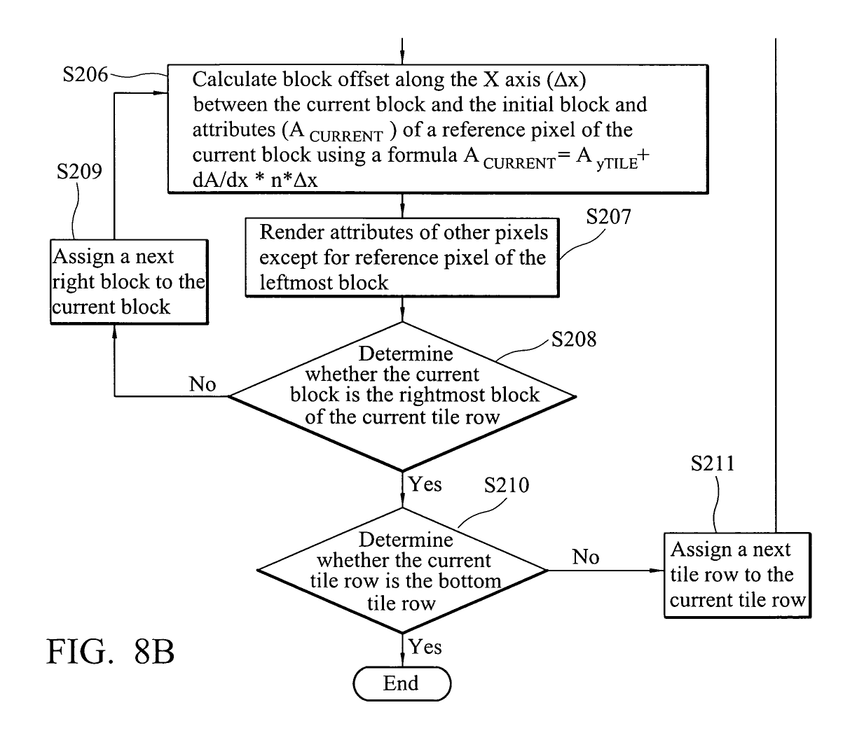

FIG. 7 is a schematic view of another embodiment of a method for image rendering. FIGS. 8A and 8B are workflows of the method for image rendering shown in FIG. 7.

Referring to FIGS. 7 and 8, the image object illustrated in FIGS. 5 and 6 is again used as an example and further description is not provided in the following, and D₁˜D₁₉ are reference pixels of each block.

A top tile row (R_{TOP}, in which reference pixel D₁ resides) a bottom tile row (R_{BOTTOM}, in which reference pixels D₁₈ and D₁₉ reside), and a current tile row (R_{CURRENT}, in which reference pixels D₄˜D₇ of the embodiment reside) of a triangle object are defined (step S201). The image rendering begins from the top tile row, thus, the top tile row is defined as the current tile row (R_{CURRENT}=R_{TOP}), and the top tile row serves as the current tile row even if selected rendering targets are tile rows comprising reference pixels D₄˜D₇.

Next, the leftmost block (T_{LEFT}), the rightmost block (T_{RIGHT}), and a current block (T_{CURRENT}) of the current tile row are defined (step S202). Because the top tile row is the initial row and comprises only one block, the block in which reference pixel D₁ resides serves as leftmost block (T_{LEFT}), the rightmost block (T_{RIGHT}), and the current block (T_{CURRENT}) of the current tile row.

It is determined whether the current tile row is the top tile row (step S203). If the current tile row is the top tile row (R_{CURRENT}=R_{TOP}), an initial process defines the leftmost block (TLEFT) of the top tile row (R_{TOP}) an initial block (T_{INIT}, in which reference pixel D₁ of this embodiment reside), the leftmost-top pixel (a reference pixel) of the initial block is defined as an initial pixel, and attributes (A_{INIT}) of the initial pixel is calculated (step S204). If the current tile row is not the top tile row (R_{CURRENT}≠R_{TOP}) or the initial process has been performed, block offset along the Y axis (Δy) between a current tile row and the initial block is calculated (step S205). The block in which pixel B₃ resides is now assigned to the current block for simplification. When the block in which pixel B₃ resides is rendered, attributes (A_{yTILE}) of a reference pixel vertically intersecting the initial pixel for the current tile row are calculated. Thus, block offset along the Y axis (Δy) between a tile row comprising blocks in which reference pixels D₄˜D₇ and the block which reference pixel D₁ resides is calculated. As shown in FIG. 7, block offset along the Y axis is 2 (Δy=2). Next, attributes (A_{yTILE}) of the vertically intersecting reference pixels are calculated using a formula A_{yTILE}=A_{INIT}+dA/dy*n*Δy (step S205), where A_{INIT} indicates attributes of the initial pixel and n relates to the block size.

Next, block offset along the X axis (Δx) between the current block (the block in which reference pixel D₆ resides) and the initial block (the block in which reference pixel D₁ resides) is calculated (step S206). In this embodiment the current block and the vertically intersecting reference pixel (A_{yTILE}) reside in the same tile row and further in the same block, thus, the block offset (Δx) is 0. Next, attributes (A_{CURRENT}) of a reference pixel of the current block are calculated using a formula A_{CURRENT}=A_{yTILE}+dA/dx*n*Δx (step S206), where n relates to the block size.

Next, attributes of other pixels, except for reference pixel D₆, of the current block are rendered (step S207). It is noted that, based on step S206 and compared with the conventional method shown in FIG. 1, when the current block of the current tile row (besides the initial block in which reference pixel A₁ resides) is rendered, an embodiment of the image rendering does not preferably calculate attributes of reference pixels A₃, A₂, A₅, and A₄ to obtain attributes of reference pixel A₆. Alternatively, when attributes (A_{INIT}) of initial pixel D₁ of the initial block is obtained, attributes (A_{CURRENT}) of reference pixel D₆ is directly obtained using steps S205 and S206, such that attribute errors for reference pixels D₃, D₂, D₅, and D₄ are not accumulated.

Next, it is determined whether the current block is the rightmost block of the current tile row (step S208). If the current block is not the rightmost block of the current tile row, a next right block is assigned to the current block (step S209), indicating the block in which reference pixel D₇ is currently the current block, and the process proceeds to step S206. If the current block is the rightmost block of the current tile row, it is then determined whether the current tile row is the bottom tile row (step S210). If the current tile row is the bottom tile row, the process ends. If the current tile row is not the bottom tile row, a next tile row is assigned to the current tile row (step S211) and the process proceeds to step S202 to render the next tile row.

An embodiment of an image rendering method renders the current block based on neither the last block nor the leftmost block of the same tile row but a reference block vertically intersecting the block of the same tile row in which the initial pixel resides.

A reference pixel of each block is referred to for rendering attributes of other pixels of the same block and attributes of reference pixels of other blocks. Thus, if each block is rendered based on the last block, differential errors are accumulated and affect to the current block. Alternatively, the method renders the current block based on the leftmost block only of the same tile row and renders the leftmost block of each tile row based on the initial block only, such that differential errors are minimized and fixed, referring to formulas shown in steps S106 and S110. In another embodiment, the current block is rendered based on a reference pixel vertically intersecting the initial pixel and each vertically intersecting block is rendered based in the initial block, such that differential errors are minimized and quantized, referring to the formulas shown in steps S205 and S206. Thus, probability occurrence of abnormal display is substantially reduced.

Methods and systems of the present disclosure, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A method for image rendering, applied to rendering an image object, wherein the image object comprises a plurality of tile rows, each tile row comprises at least one block, and each block comprises a reference pixel, the method comprising:
defining a top tile row (R_{TOP}), a bottom tile row, and a current tile row of the image object;
defining the leftmost block of the top tile row as an initial block (T_{INIT}) and the reference pixel of the initial block as an initial pixel;
calculating block offset along the X and Y axes (Δx and Δy) between a leftmost block of the current tile row and the initial block;
calculating attributes (A_{LEFT}) of a reference pixel of the leftmost block using a formula A_{LEFT}=A_{INIT}+dA/dx*n*Δx+dA/dy*n*Δy, where A_{INIT} indicates attributes of the initial pixel;
calculating block offset (Δz) between a current block and the leftmost block, wherein the current block and the leftmost block reside in the same tile row; and
calculating attributes (A_{CURRENT}) of a reference pixel of the current block using a formula A_{CURRENT}=A_{LEFT}+dA/dx*n*Δz, where Δz is the block offset between the current block and the leftmost block and n relates to the block size.

2. The method for image rendering as claimed in claim 1, further comprising:
when the attributes (A_{LEFT}) of the reference pixel of the leftmost block are obtained, rendering attributes of other pixels of the leftmost block; and
when the attributes (A_{CURRENT}) of the reference pixel of the current block is obtained, rendering attributes of other pixels of the current block.

3. The method for image rendering as claimed in claim 1, further comprising:
when the current tile row is the top tile row, setting the initial pixel and the initial block (T_{INIT}) and calculating attributes (A_{INIT}) of the initial pixel; and
when the current tile row is not the top tile row, calculating the block offset along the X and Y axes (Δx and Δy) and the attributes (A_{LEFT}) of the reference pixel of the leftmost block.

4. The method for image rendering as claimed in claim 1, wherein n relates to the block size.

5. The method for image rendering as claimed in claim 1, further comprising:
when the current block is not the rightmost block, assigning the next right block to the current block;
calculating attributes (A_{CURRENT}) of a reference pixel of the next right block using a formula A_{CURRENT}=A_{LEFT}+dA/dx*n*Δz; and
rendering attributes of other pixels of the next right block.

6. The method for image rendering as claimed in claim 5, wherein n relates to the block size.

7. The method for image rendering as claimed in claim 1, further comprising:
when the current block is the rightmost block and the current tile row is the bottom tile row, terminating the image rendering; and
when the current block is the rightmost block of the current tile row and the current tile row is not the bottom tile row, assigning the next tile row to the current tile row and continuously rendering the next tile row.

8. The method for image rendering as claimed in claim 1, wherein a reference pixel is the leftmost-top pixel of each block.

9. A method for image rendering, applied to rendering an image object, wherein the image object comprises a plurality of tile rows, each tile row comprises at least one block, and each block comprises a reference pixel, the method comprising:
defining the leftmost block of a top tile row (R_{TOP}) as an initial block (T_{INIT}) and a reference pixel of the initial tile as an initial pixel;
calculating block offset along the Y axis (Δy) between a current tile row and the initial block;
calculating attributes (A_{yTILE}) of a reference pixel vertically intersecting the initial pixel for the current tile row using a formula A_{yTILE}=A_{INIT}+dA/dy*n*Δy, where A_{INIT} indicates attributes of the initial pixel;
calculating block offset along the X axis (Δx) between a current block and the initial block, wherein the current block and the vertically intersecting reference pixel reside in the same tile row; and
calculating attributes (A_{CURRENT}) of a reference pixel of the current block using a formula A_{CURRENT}=A_{yTILE}+dA/dx*n*Δx, where n relates to the block size.

10. The method for image rendering as claimed in claim 9, further comprising rendering attributes of other pixels of the current block when the attributes (A_{CURRENT}) of the reference pixel of the current block are obtained.

11. The method for image rendering as claimed in claim 9, further comprising:
when the current tile row is the top tile row, setting the initial pixel and the initial block (T_{INIT}) and calculating attributes (A_{INIT}) of the initial pixel; and
when the current tile row is not the top tile row, calculating the block offset along the X and Y axes (Δx and Δy) and the attributes (A_{yTILE}) of the vertically intersecting reference pixel.

12. The method for image rendering as claimed in claim 9, wherein n relates to the block size.

13. The method for image rendering as claimed in claim 9, further comprising:
when the current block is not the rightmost block, assigning the next right block to the current block;
calculating attributes (A_{CURRENT}) of a reference pixel of the next right block using a formula A_{CURRENT}=A_{yTILE}+dA/dx*n*Δz; and
rendering attributes of other pixels of the next right block.

14. The method for image rendering as claimed in claim 13, wherein n relates to the block size.

15. The method for image rendering as claimed in claim 9, further comprising:
when the current block is the rightmost block and the current tile row is a bottom tile row, terminating the image rendering; and
when the current block is the rightmost block of the current tile row and the current tile row is not the bottom tile row, assigning the next tile row to the current tile row and continuously rendering the next tile row.

16. The method for image rendering as claimed in claim 9, wherein a reference pixel is the leftmost-top pixel of each block.
